(19) United States
(12) Patent Application Publication
(10) Pub. No.: US 2026/0285122 A1
(43) Pub. Date: Sep. 24, 2026

(54) UNIT COOLER

(71) Applicant: KABUSHIKI KAISHA TOYOTA JIDOSHOKKI, Aichi (JP)

(72) Inventors: Satoru SHIMADA, Kariya-shi, Aichi (JP); Hisaya KONDO, Kariya-shi, Aichi (JP); Ryota WATANABE, Kariya-shi, Aichi (JP); Yuta ISHIDA, Kariya-shi, Aichi (JP); Riichiro SANO, Kariya-shi, Aichi (JP)

(73) Assignee: KABUSHIKI KAISHA TOYOTA JIDOSHOKKI, Aichi (JP)

(21) Appl. No.: 19/473,699

(22) PCT Filed: Jan. 18, 2024
(86) PCT No.: PCT/JP2024/001257

§ 371 Date: Oct. 8, 2025

(30) Foreign Application Priority Data
Apr. 14, 2023 (JP) 2023-066292

(51) Int. Cl. B60H 1/00

(52) U.S. Cl. CPC B60H 1/00521

(57) ABSTRACT

A unit cooler includes a housing and an air conditioner cooling air and supplying the air to an outside of the housing. The housing has a base plate, an under cover, and a top cover. The air conditioner has an electric compressor, a condenser, a decompression device, an evaporator, a first fan, and a second fan. A fastening member is provided between the base plate and the under cover. At least one of the condenser and the evaporator is disposed between the under cover and the top cover and has an extending portion that extends out of the base plate. A collision cushioning member is provided on the extending portion.

### TECHNICAL FIELD

The present invention relates to a unit cooler.

### BACKGROUND ART

A conventional unit cooler is disclosed in Patent Literature 1. This unit cooler is used in an industrial vehicle such as a forklift truck, which has a power supply.

This unit cooler in Patent Literature 1 includes a housing and an air conditioner that is accommodated in the housing. The air conditioner has an electric compressor, a condenser, a decompression device, an evaporator, and a control device and forms a refrigeration cycle. The evaporator has a discharge duct. The housing has a first cover in which the electric compressor, the condenser, the decompression device, and the evaporator are accommodated, a second cover in which the control device is accommodated, an attachment plate, and a flat plate. The first cover in which the electric compressor, the condenser, the decompression device, and the evaporator are accommodated and the second cover in which the control device is accommodated are fixed to the attachment plate with bolts. The flat plate is fixed to the industrial vehicle with the bolts. Anti-vibration rubber is provided between the attachment plate and the flat plate, and the attachment plate, the anti-vibration rubber, and the flat plate are fixed with the bolts.

In this unit cooler, for example, in an industrial vehicle that does not have as many means for reducing vibrations as a passenger car, the electric compressor of the air conditioner is operated by a power supply to cool air, and the cooled air is supplied to an outside of the housing through the discharge duct. During this operation, the anti-vibration rubber suppresses that the vibrations while the industrial vehicle travels or operates are transmitted to the electric compressor or the like in the first cover and the control device in the second cover to reduce their failures. The anti-vibration rubber also contributes to quietness by absorbing the vibrations of the electric compressor.

### CITATION LIST

### Patent Literature

Patent Literature 1: Japanese Patent Application Publication No. H07-083464

### SUMMARY OF INVENTION

### Technical Problem

However, in the above-described conventional unit cooler, the air conditioner is only fixed to the attachment plate through the first cover and the second cover, so that the air conditioner is likely to vibrate. Accordingly, it is desirable that vibration resistance and impact resistance of the unit cooler are improved.

In this regard, it may be considered to adopt a housing having a base plate, an under cover, and a top cover. An air conditioner is mounted on the base plate. The under cover is disposed under the base plate. The top cover is fixed to the under cover and surrounds the air conditioner together with the under cover. In addition, a fastening member that has a vibration isolating property may be provided between the base plate and the under cover. In this case, the fastening member suppresses that the vibrations from the outside are transmitted to the air conditioner on the base plate to reduce failures of the air conditioner, and the fastening member absorbs the vibrations of the air conditioner to also contribute to quietness.

Even in the unit cooler improved as described above, a condenser may extend out of the base plate, and an evaporator may extend out of the base plate in a direction opposite from a direction in which the condenser extends out of the base plate, when the air conditioner that has a first fan adjacent to the condenser and a second fan adjacent to the evaporator is adopted. This occurs when, for example, a large condenser or evaporator is adopted in terms of a heat exchange capacity. In this case, when the condenser or the evaporator is provided between the under cover and the top cover, the condenser or the evaporator collides with the under cover or the top cover because of the vibrations from the outside, which may cause abnormal noise. Moreover, there are concerns about durability of a structure that is formed by integrating the base plate with the air conditioner or the like. In particular, because the fastening member has the vibration isolating property, when the frequency of vibrations from the outside matches a natural frequency of the structure, the structure resonates, which increases concerns.

The present invention is made in view of the conventional circumstances described above and is directed to providing a unit cooler that may supply cold air to an outside of the housing and that is superior in quietness and durability.

### Solution to Problem

A unit cooler of the present invention includes a housing and an air conditioner that is accommodated in the housing and forms a refrigeration cycle, the air conditioner cooling air and supplying the air to the outside of the housing. The unit cooler is characterized in that the housing has a base plate on which the air conditioner is mounted, an under cover that is disposed under the base plate, a top cover that is fixed to the under cover and surrounds the air conditioner together with the under cover, the air conditioner has an electric compressor, a condenser, a decompression device, an evaporator, a first fan adjacent to the condenser, a second fan adjacent to the evaporator, a fastening member that has a vibration isolating property is provided between the base plate and the under cover, at least one of the condenser and the evaporator is disposed between the under cover and the top cover and has an extending portion that extends out of the base plate in a direction opposite from the fan adjacent to the condenser and the evaporator, and a collision cushioning member that cushions an impact of a collision between the at least one of the condenser and the evaporator and the under cover or the top cover is provided on the extending portion.

In the unit cooler of the present invention, the air conditioner forms a refrigeration cycle and cools air and supplies the air to the outside of the housing.

Also, in this unit cooler, since the housing that has the base plate, the under cover, and the top cover is adopted, and the fastening member that has the vibration isolating property is provided between the base plate and the under cover, this configuration suppresses that vibrations from the outside are transmitted to the air conditioner on the base plate to reduce failures of the air conditioner and this absorbs the vibrations of the air conditioner to also contribute to quietness.

In addition, in this unit cooler, although the at least one of the condenser and the evaporator is disposed between the under cover and the top cover and has the extending portion that extends out of the base plate in a direction opposite from the fan adjacent to the at least one of the condenser and the evaporator, and a collision cushioning member is provided on the extending portion. Thus, the collision cushioning member cushions the impact of the collision between the at least one of the condenser and the evaporator and the under cover or the top cover.

Thus, the unit cooler of the present invention may supply the cold air to the outside of the housing and is superior in quietness and durability.

The housing may have an upper plate that is disposed between the top cover and the base plate. The first fan may be accommodated in a first case made of metal and the second fan may be accommodated in a second case made of metal. Preferably, the first case and the second case are located between the base plate and the upper plate and fixed to the base plate and the upper plate. In this case, since the structure integrates more closely, which leads to superior vibration resistance and impact resistance. On the other hand, the condenser or the evaporator is more likely to collide with the under cover or the top cover, which increases the necessity of the present invention.

In a case where the condenser has the extending portion, it is preferable that the collision cushioning member includes at least a first layer of the first layer that has predetermined thermal insulation, a second layer that is located between the first layer and the condenser, and a third layer that is located between the first layer and the under cover and between the first layer and the top cover. In this case, the first layer may prevent a high temperature of the condenser from negatively affecting the cold air.

In a case where the evaporator has the extending portion, it is preferable that the collision cushioning member includes at least a first layer of the first layer that has predetermined thermal insulation, a second layer that is located between the first layer and the evaporator, and a third layer that is located between the first layer and the under cover and between the first layer and the top cover. In this case, the first layer may prevent a low temperature of the evaporator from leaking to the outside.

Preferably, the collision cushioning member has heat resistance, flame retardancy, and a self-extinguishing property. In this case, it is prevented that the condenser or the evaporator is combusted.

Preferably, the collision cushioning member has a groove that allows the collision cushioning member to be deformed. In this case, the condenser or the evaporator is hardly deformed by the vibrations from the outside, which contributes to superior durability.

Preferably, the collision cushioning member has a cutout into which the evaporator is fitted and guides condensation water generated in the air conditioner onto the under cover. In this case, the cutout provides an effect that guides the condensation water onto the under cover so as not to mix the condensation water into the cold air, or the like.

### Advantageous Effects of Invention

The unit cooler of the present invention may supply the cold air to the outside of the housing and is superior in vibration resistance and impact resistance.

### BRIEF DESCRIPTION OF DRAWINGS

FIG. 1 is a side view illustrating a forklift truck on which a unit cooler according to a first embodiment is mounted.

FIG. 2 is an exploded perspective view illustrating the unit cooler according to the first embodiment.

FIG. 3 is a plan view illustrating a state in which a top cover and an upper plate are removed from the unit cooler according to the first embodiment.

FIG. 4 is a cross-sectional view illustrating a structure and an under cover in the unit cooler according to the first embodiment.

FIG. 5 is a perspective view illustrating a third case in the unit cooler according to the first embodiment.

FIG. 6 is a cross-sectional view illustrating the third case in the unit cooler according to the first embodiment.

FIG. 7 is a cross-sectional view illustrating the unit cooler with a cold air guiding portion and a pipe omitted in the unit cooler according to the first embodiment.

FIG. 8 is a cross-sectional view illustrating a fastening member in the unit cooler according to the first embodiment.

FIG. 9 is an enlarged cross-sectional view illustrating an attaching portion to a forklift truck in the unit cooler according to the first embodiment.

FIG. 10 is a cross-sectional view illustrating a unit cooler with a cold air guiding portion and a pipe omitted according to a second embodiment.

FIG. 11 is a plan view illustrating a headguard and the unit cooler according to the first embodiment or the second embodiment in another forklift truck.

FIG. 12 is a perspective view illustrating the headguard and the unit cooler in the forklift truck of FIG. 11 as viewed from a front of them.

FIG. 13 is a plan view similar to FIG. 11 in a case where a mounted position of the unit cooler according to the first embodiment or the second embodiment is changed.

FIG. 14 is a plan view similar to FIG. 11 in a case where the mounted position of the unit cooler according to the first embodiment or the second embodiment is further changed.

### DESCRIPTION OF EMBODIMENTS

The following will describe a first embodiment and a second embodiment according to the present invention with reference to accompanying drawings.

### First Embodiment

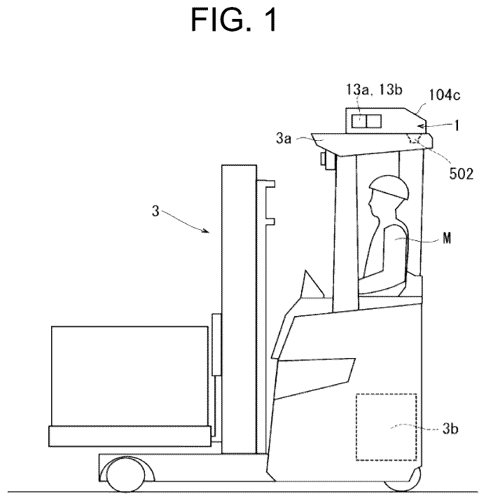

As illustrated in FIG. 1, a unit cooler 1 of the first embodiment is fixed onto a headguard 3a of a reach-type electric forklift truck 3 as the industrial vehicle. The forklift truck 3 has a battery 3b as the power source. When a driver M operates the forklift truck 3, the forklift truck 3 travels and performs cargo handling work by power supplied from the battery 3b.

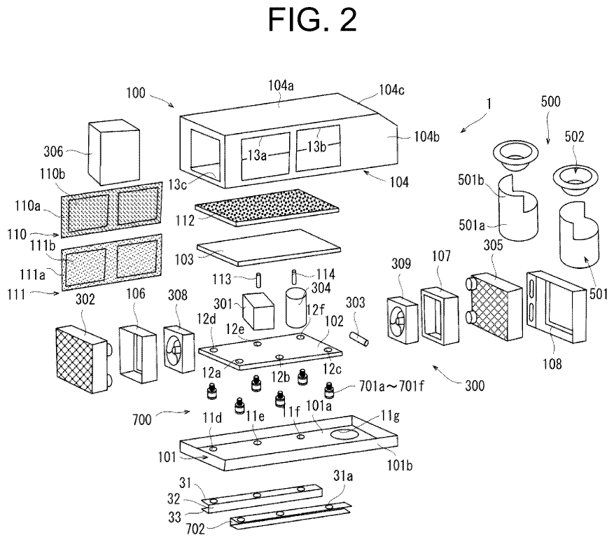

This unit cooler 1, as illustrated in FIG. 2, includes a housing 100, an air conditioner 300, and a cold air guiding portion 500. The housing 100 has an under cover 101, a base plate 102, an upper plate 103, and a top cover 104.

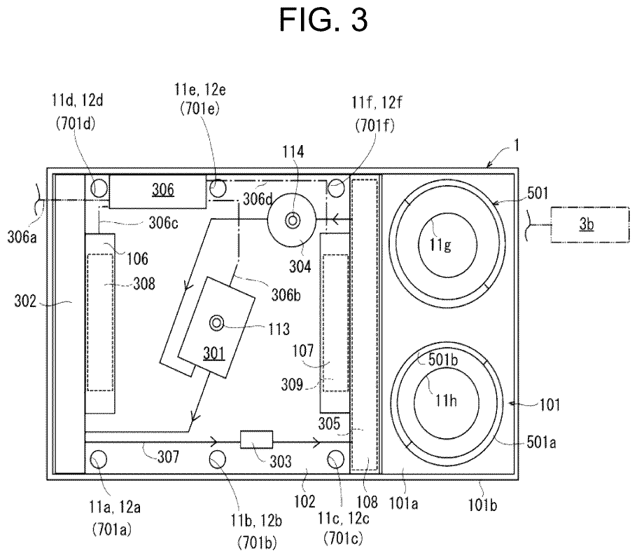

The under cover 101 is made of metal. The under cover 101 includes a bottom plate 101a formed in a rectangular shape and a peripheral wall 101b extending upward from four sides of the bottom plate 101a and connected to each other. Six bolt holes 11a to 11f and two cold air ventilation ports 11g, 11h extend through the bottom plate 101a, as illustrated in FIG. 3. In FIG. 3, in a left area of the bottom plate 101a relative to a center thereof, three of the bolt holes 11a to 11f are formed along one long side of the bottom plate 101a and the remaining three of the bolt holes 11a to 11f are formed along the other long side of the bottom plate 101a. The cold air ventilation ports 11g, 11h are formed on upper and lower portions of the bottom plate 101a in a right area of the bottom plate 101a. The three bolt holes 11a to 11c along the one long side are arranged at regular intervals, and the three bolt holes 11d to 11f along the other long side are also arranged at regular intervals. Note that the bolt hole 11b may be located close to the bolt hole 11a or the bolt hole 11c, and the bolt hole 11e may be located close to the bolt hole 11d or the bolt hole 11f.

The base plate 102 is made of metal. As illustrated in FIG. 2, the base plate 102 is a flat plate formed in a rectangular shape whose long sides are shorter than those of the bottom plate 101a of the under cover 101 that is disposed under the base plate 102. Six bolt holes 12a to 12f, which are aligned with the bolt holes 11a to 11f of the under cover 101, extend through the base plate 102. In FIG. 3, three of the bolt holes 12a to 12f are formed along one long side of the base plate 102 and the remaining three of the bolt holes 12a to 12f are formed along the other long side of the base plate 102. A plurality of bolt holes, which is not illustrated, extends through the base plate 102 and is used for fixing a first case 106, an electric compressor 301, an accumulator 304, a second case 107, and a third case 108, which will be described later.

The upper plate 103 is made of metal. As illustrated in FIG. 2, the upper plate 103 is also a flat plate formed in a rectangular shape. The upper plate 103 is disposed between the top cover 104 and the base plate 102. The upper plate 103 does not have bolt holes such as the bolt holes 12a to 12f of the base plate 102. A plurality of bolt holes, which is not illustrated, extends through the upper plate 103 and is used for fixing the first case 106 and the second case 107, which will be described later.

The top cover 104 is made of metal. The top cover 104 has a top plate 104a formed in a rectangular shape, an inclined plate 104c inclining downwards from one end of the top plate 104a, and a peripheral wall 104b extending downwards from three sides of the inclined plate 104c and from three sides of the top plate 104a and connected to each other. The top plate 104a is thicker than the bottom plate 101a of the under cover 101 by the thickness of the top cover 104. The top cover 104 is fixed to the under cover 101 with bolts, which are not illustrated.

The peripheral wall 104b of the top cover 104 has two suction ports 13a, 13b located in one long side of the top plate 104a and a heat releasing port 13c located in one short side of the top plate 104a adjacently to the suction port 13a. A first filter 110 and a second filter 111 are attachable to the suction ports 13a, 13b. The heat releasing port 13c is located opposite to the inclined plate 104c across the top plate 104a.

The first filter 110 includes a first frame 110a that is fixed to the peripheral wall 104b of the top cover 104 and a metal mesh 110b. Two openings, which are aligned with the suction ports 13a, 13b, extend through the first frame 110a. The metal mesh 110b is fixed to the first frame 110a so as to cover both the openings.

The second filter 111 includes a second frame 111a that is fixed to the peripheral wall 104b of the top cover 104 and a sponge 111b. Two openings, which are aligned with the suction ports 13a, 13b, extend through the second frame 111a. The sponge 111b is removably attached to the second frame 111a so as to cover both the openings. The first filter 110 and the second filter 111 are also a part of the housing 100.

The air conditioner 300 has the electric compressor 301, a condenser 302, an expansion valve 303, the accumulator 304, an evaporator 305, and a control device 306. The expansion valve 303 corresponds to a decompression device. As illustrated in FIG. 3, the electric compressor 301, the condenser 302, the expansion valve 303, the evaporator 305, and the accumulator 304 are connected in this order by pipes 307 and they form a refrigeration cycle through which a refrigerant circulates. The condenser 302 and the evaporator 305 are the same rectangular parallelepiped shape. A first fan 308 is disposed on the condenser 302 near the electric compressor 301 and a second fan 309 is disposed on the evaporator 305 near the accumulator 304. The second fan 309 is disposed on the evaporator 305 near the electric compressor 301. The first fan 308 and the second fan 309 are also a part of the air conditioner 300.

The control device 306 includes a harness 306a and connecting cords 306b, 306c, 306d. The harness 306a passes along the backside of the under cover 101 and is connected to the battery 3b in the forklift truck 3. The control device 306 is fixable on the base plate 102.

The connecting cord 306b is connected to the electric compressor 301, so that the electric compressor 301 is operated by the control device 306 to circulate the refrigerant in the air conditioner 300. The connecting cord 306c is connected to the first fan 308, and the connecting cord 306d is connected to the second fan 309. Outside air is sucked into the top cover 104 from the suction ports 13a, 13b through a first filter 110 and a second filter 111 by the first fan 308 and the second fan 309 that are operated by the control device 306. The first fan 308 supplies the air in the top cover 104 to the condenser 302. The second fan 309 supplies the air in the top cover 104 to the evaporator 305.

As illustrated in FIG. 2, the condenser 302 is fixed to the first case 106. The first fan 308 is accommodated in the first case 106. The evaporator 305 is fixed to the second case 107. The second fan 309 is accommodated in the second case 107. A fan shroud is formed of the first case 106 and the second case 107. The first to third cases 106 to 108 are each formed in a rectangular parallelepiped shape. The first case 106 and the second case 107 have the same shape and are smaller than the third case 108. The first to third cases 106 to 108 also correspond to a part of the housing 100. The first case 106 is made of metal. The second case 107 is made of metal. The first case 106 and the second case 107, for example, are made of stainless steel.

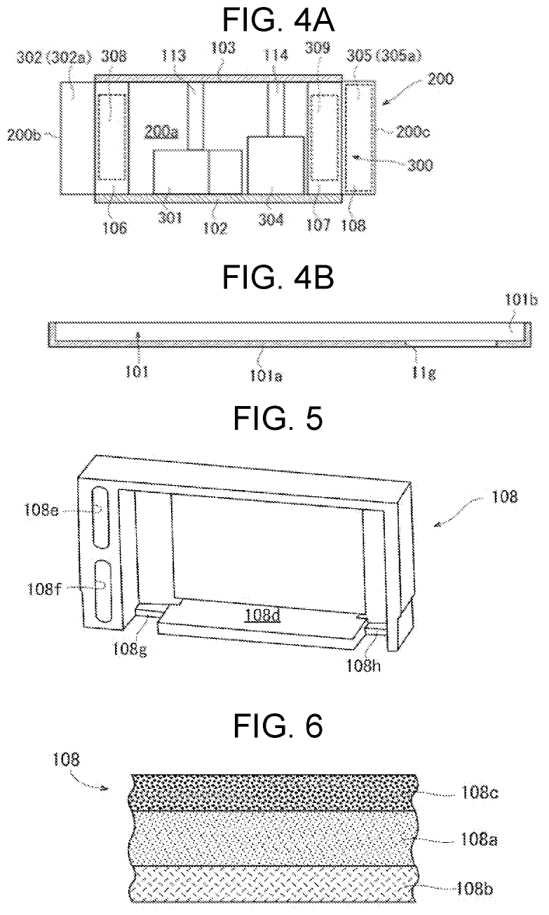

As illustrated in FIG. 3 and FIG. 4, the first case 106 in which the first fan 308 is accommodated, the electric compressor 301, the accumulator 304, the second case 107 in which the second fan 309 is accommodated, and the control device 306 are fixed to a top surface of the base plate 102 with the bolts or the like, which are not illustrated.

Here, in terms of a heat exchange capacity, at least one of the condenser 302 and the evaporator 305 is disposed between the under cover 101 and the top cover 104 and has an extending portion that extends out of the base plate 102 in a direction opposite from the first fan 308 or the second fan 309 adjacent to the at least one of the condenser 302 and the evaporator 305. In the first embodiment, as illustrated in FIG. 4, the condenser 302 extends out of the base plate 102. The portion of the condenser 302 that extends out of the base plate 102 is the extending portion 302a. The evaporator 305 extends out of the base plate 102 in the direction opposite from the direction in which the condenser 302 extends out of the base plate 102. The portion of the evaporator 305 that extends out of the base plate 102 is the extending portion 305a. Thus, the third case 108 is provided on the outer peripheral surface of the evaporator 305 that includes the extending portion 305a. The third case 108 corresponds to a collision cushioning member.

As illustrated in FIG. 5, a fitting hole 108d into which the evaporator 305 or the condenser 302 is fitted is formed in the third case 108. As illustrated in FIG. 6, the third case 108 includes a first layer 108a that has predetermined thermal insulation, a second layer 108b that is located between the first layer 108a and either of the evaporator 305 or the condenser 302, and a third layer 108c that is located between the first layer 108a and the under cover 101 and located between the first layer 108a and the top cover 104.

As illustrated in FIG. 5, two grooves 108e, 108f that allow the third case 108 to be deformed are formed in the first layer 108a and arranged in a row in a vertical direction. In addition, two cutouts 108g, 108h through which both ends of the evaporator 305 or the condenser 302 in a width direction thereof are exposed are formed in a bottom wall of the third case 108.

The first layer 108a is formed of countless polyamide foam beads that are bonded to each other. The second layer 108b and the third layer 108c are formed of sponges with different densities. The third case 108 includes at least the first layer 108a and has heat resistance, flame retardancy, and a self-extinguishing property due to the first layer 108a.

The electric compressor 301, the condenser 302, the expansion valve 303, the accumulator 304, and the evaporator 305 are connected to each other by the pipes 307, and the refrigerant is sealed therein. In addition, as illustrated in FIG. 4, the upper plate 103 is fixed to the first case 106 and the second case 107 with bolts or the like, which are not illustrated.

A first collar 113 and a second collar 114 each having a cylindrical shape are formed from the same cylindrical member. The first collar 113 is disposed between the electric compressor 301 and the upper plate 103 in contact with the electric compressor 301 and the upper plate 103. The second collar 114 is disposed between the accumulator 304 and the upper plate 103 in contact with the accumulator 304 and the upper plate 103. Here, the first collar 113 and the second collar 114 are disposed so that the center of gravity of the electric compressor 301 is located on an extension of the first collar 113 and the center of gravity of the accumulator 304 is located on an extension of the second collar 114. Then, the base plate 102, the upper plate 103, and the air conditioner 300 are integrated to form a structure 200.

This structure 200, on the sides thereof, has a first opening 200a facing the suction ports 13a, 13b in the top cover 104, a second opening 200b being adjacent to the first opening 200a and facing the heat releasing port 13c, and a third opening 200c being adjacent to the first opening 200a and located on the opposite side of the second opening 200b. The condenser 302 is exposed from the second opening 200b. The evaporator 305 is exposed from the third opening 200c.

As illustrated in FIG. 2, the cold air guiding portion 500 is formed of an inner surface of the top cover 104, in particular, an inner surface of the inclined plate 104c, the two cold air ventilation ports 11g, 11h of the under cover 101, two shades 501, and two punkah-louvers 502. The shades 501 are each fixed around a corresponding one of the cold air ventilation ports 11g, 11h in the under cover 101 together with the punkah-louver 502 with bolts, which are not illustrated, so as to face the third case 108 in which the evaporator 305 is accommodated.

Each of the shades 501 includes a cylindrical portion 501a that is formed in a cylindrical shape extending in a vertical axial direction of the shade 501, and an eaves portion 501b that is formed in an arc shape integrally with the cylindrical portion 501a in an upper portion of the shade 501 in the axial direction. The outer surface of each of the eaves portion 501b faces the evaporator 305 and causes the cold air to detour into the cylindrical portion 501a when the cold air sent from the evaporator 305 blows onto the outer surface.

Each of the punkah-louvers 502 is disposed in a lower portion of the cylindrical portion 501a of a corresponding one of the shades 501 in the axial direction thereof. An air outlet of each of the punkah-louvers 502 is turned, and the cold air is sent to the driver from the air outlet of the punkah-louver 502.

The unit cooler 1 is assembled to the forklift truck 3 by a fastening means 700 and fixed to the forklift truck 3. The fastening means 700 includes six fastening members 701a to 701f, two under rails 702 each formed in a U-shape with corners at right angles when viewed in a cross section, a plurality of bolts 703, and a plurality of nuts 704.

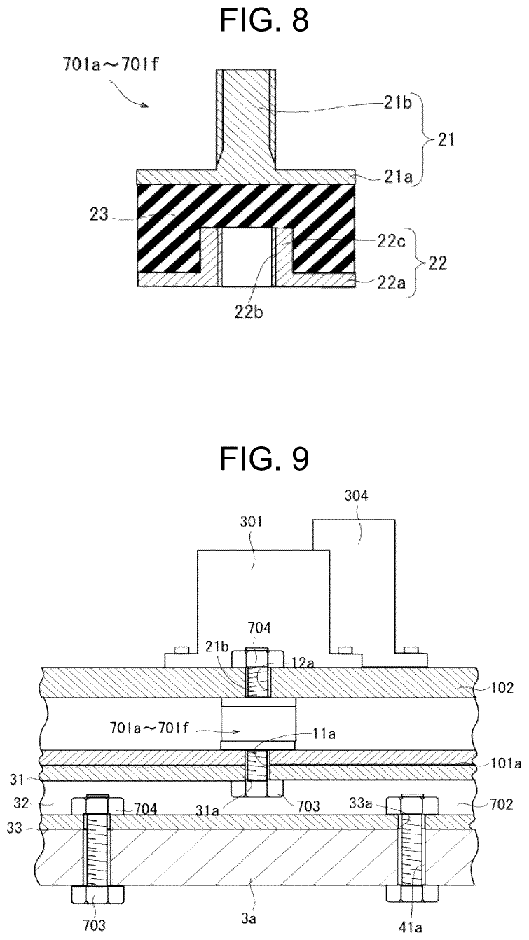

The fastening members 701a to 701f, as illustrated in FIG. 8, are each formed of a first member 21, a second member 22, and a middle member 23. The first member 21 includes a circular plate portion 21a having a circular plate shape and an external screw portion 21b that is integrally formed with the circular plate portion 21a and extends in an axial direction perpendicular to the circular plate portion 21a from the center of the circular plate portion 21a. The second member 22 includes a circular plate portion 22a having a circular plate shape and a boss portion 22c that is integrally formed with the circular plate portion 22a and extends in the same direction as a direction in which the external screw portion 21b extends from the center of the circular plate portion 22a and in which an internal screw portion 22b is formed. The external screw portion 21b corresponds to a first screw portion and the internal screw portion 22b corresponds to a second screw portion. The middle member 23 is made of natural rubber having an insulation property and a vibration isolating property. The middle member 23 connects the circular plate portion 21a of the first member 21 to the circular plate portion 22a and the boss portion 22c of the second member 22.

As illustrates in FIG. 2, each of the under rails 702 is formed of an upper rail plate 31, a lower rail plate 33, and a side rail plate 32 connecting the upper rail plate 31 to the lower rail plate 33. Three bolt holes 31a, which are aligned with the bolt holes 11a to 11f of the bottom plate 101a in the under cover 101, extend through the upper rail plate 31. As illustrated in FIG. 9, bolt holes 41a of the suitable number extend vertically through the headguard 3a of the forklift truck 3. A bolt hole 33a, which is aligned with the bolt hole 41a of the headguard 3a, extends through the lower rail plate 33 of each of the under rails 702. The harness 306a is guided to a rear of the forklift truck 3 along the under rail 702 near the control device 306 on the backside of the under cover 101. In this case, for example, the harness 306a is held to the side rail plate 32 by a holding member, which is not illustrated.

In a case where the unit cooler 1 is fixed to the forklift truck 3, as illustrated in FIG. 4, first, the structure 200 is prepared. In addition, the shades 501 and the punkah-louvers 502 are fixed to the under cover 101. Then, as illustrated in FIG. 9, the two under rails 702 are fixed to the headguard 3a of the forklift truck 3 with the bolts 703 and the nuts 704, and the under cover 101 is mounted on the under rails 702.

In this state, the bolts 703 are inserted into the bolt holes 31a and the bolt holes 11a to 11f and screwed into the internal screw portions 22b of the fastening members 701a to 701f. The first fastening member 701a is disposed in the bolt hole 11a of the under cover 101 and the bolt hole 12a of the base plate 102, and the first fastening member 701d is disposed in the bolt hole 11d of the under cover 101 and the bolt hole 12d of the base plate 102. The first fastening members 701a, 701d are disposed with the first fan 308 interposed therebetween. The second fastening member 701c is disposed in the bolt hole 11c of the under cover 101 and the bolt hole 12c of the base plate 102, and the second fastening member 701f is disposed in the bolt hole 11f of the under cover 101 and the bolt hole 12f of the base plate 102. The second fastening members 701c, 701f are disposed with the second fan 309 interposed therebetween.

When the under cover 101 and the under rails 702 are fixed with the fastening members 701a to 701f, the external screw portions 21b of the fastening members 701a to 701f are inserted into the bolt holes 12a to 12f of the base plate 102, and the nuts 704 are screwed onto the external screw portion 21b. Even when the under cover 101 is relatively thin, the under cover 101 is firmly fixed to the headguard 3a.

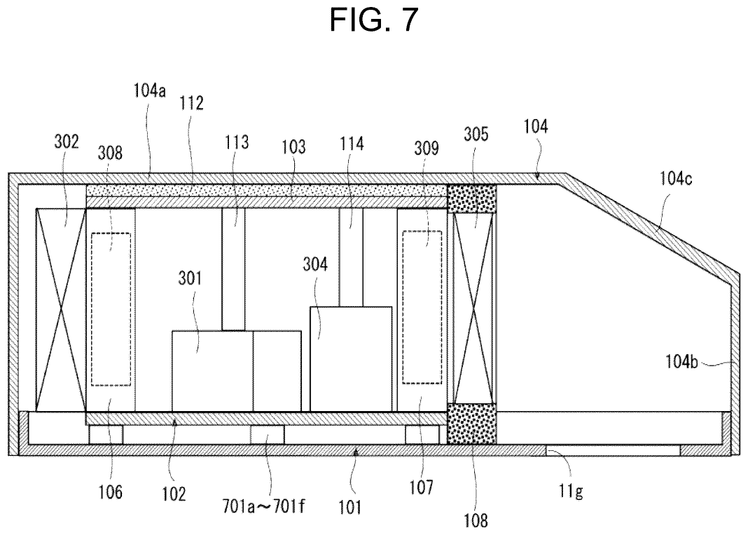

In addition, as illustrated in FIG. 3, the connecting cords 306b, 306c, 306d of the control device 306 are connected to the electric compressor 301, the first fan 308, and the second fan 309, respectively. Afterwards, sponge rubber 112, which is illustrated in FIG. 2, is placed on the structure 200, the top cover 104 is placed on the under cover 101, as illustrated in FIG. 7, and the top cover 104 is fixed on the under cover 101 with a bolt, which is not illustrated. The top cover 104 surrounds the air conditioner 300 together with the under cover 101. The sponge rubber 112 corresponds to an anti-vibration member. The unit cooler 1 of the first embodiment is mounted on the headguard 3a of the forklift truck 3 as described above.

Note that after all components illustrated in FIG. 2 may be assembled to each other and the under rails 702 may be fixed to the under cover 101, the under rails 702 may be fixed to the headguard 3a of the forklift truck 3. Moreover, by removing the bolt 703 and the nut 704 and performing the above operations in reverse, this unit cooler 1 may be mounted on other industrial vehicles.

In this unit cooler 1, in the forklift truck 3 that does not have as many means for reducing vibrations as a passenger car, the electric compressor 301, the first fan 308, and the second fan 309 of the air conditioner 300 are operated by the battery 3b. Thus, warm air is exhausted from the condenser 302 and discharged from the heat releasing port 13c to the outside of the unit cooler 1. Furthermore, cold air flows from the evaporator 305, passes through the shades 501, and is blown out from the punkah-louvers 502 toward the driver M. At this time, the inner surface of the top cover 104, in particular, the inner surface of the inclined plate 104c suitably rectifies the cold air toward the punkah-louvers 502. The driver M may change the direction in which the cold air flows out of the punkah-louvers 502 as desired, such as toward the base of the driver M's neck, by changing the direction of the air outlet of each of the punkah-louvers 502.

In this unit cooler 1, the housing 100 that has the base plate 102, the under cover 101, and the top cover 104 is adopted, and the fastening members 701a to 701f that each have a vibration isolating property are provided between the base plate 102 and the under cover 101. Accordingly, the fastening members 701a to 701f suppress that the vibrations from the outside are transmitted to the air conditioner 300 on the base plate 102 to reduce failures of the air conditioner 300, and the fastening members 701a to 701f absorb the vibrations of the air conditioner 300 to also contribute to quietness.

Also, in this unit cooler 1, the housing 100 includes the base plate 102 and the upper plate 103, which form the structure 200 together. The first case 106 in which the first fan 308 of the air conditioner 300 is accommodated and the second case 107 in which the second fan 309 is accommodated are located between the base plate 102 and the upper plate 103 and fixed to the base plate 102 and the upper plate 103. Furthermore, the electric compressor 301 of the air conditioner 300 is disposed between the base plate 102 and the upper plate 103 and between the first fan 308 and the second fan 309. The structure 200 has, on the sides thereof, the first opening 200a, the second opening 200b, and the third opening 200c. The air conditioner 300 sucks in the outside air through the first opening 200a, exhausts the warm air through the second opening 200b, and blows the cold air through the third opening 200c. Thus, the air conditioner 300 is integrated with the structure 200, so that the air conditioner 300 is less likely to vibrate while the forklift truck 3 travels and operates.

On the other hand, in this unit cooler 1, the evaporator 305 extends out of the base plate 102. Thus, the evaporator 305 is more likely to collide with the under cover 101 and the top cover 104.

However, in this unit cooler 1, the third case 108 is provided on the evaporator 305. Even when the frequency of the vibrations from the outside matches a natural frequency of the structure 200 because for example, the middle member 23 of each of the fastening members 701a to 701f has the vibration isolating property and the structure 200 resonates, the third case 108 cushions an impact of a collision between the at least one of the condenser 302 and the evaporator 305 and the under cover or the top cover.

Accordingly, this unit cooler 1 may send the cold air to the driver M of the forklift truck 3 and is superior in quietness and durability.

In addition, in this unit cooler 1, the first layer 108a of the third case 108 may prevent a low temperature of the evaporator 305 from leaking to the outside of the housing 100. Since the third case 108 has the heat resistance, the flame retardancy, and the self-extinguishing property, it is prevented that the evaporator 305 is combusted.

Furthermore, in this unit cooler 1, since the grooves 108e, 108f are formed in the third case 108, the evaporator 305 is hardly deformed by the vibrations from the outside, which contributes to superior durability. In addition, since the cutouts 108g, 108h are formed in the third case 108, the cutouts 108g, 108h generate an effect of guiding condensation water generated in the evaporator 305 onto the under cover 101 so as not to mix the condensation water into the cold air, or the like.

Also, in this forklift truck 3, as illustrated in FIG. 1, the suction ports 13a, 13b of the unit cooler 1 are located above the headguard 3a, so that noise from the unit cooler 1 hardly disturbs the driver M. In addition, the suction ports 13a, 13b of the unit cooler 1 are located on a left end side of the headguard 3a, so that the first filter 110 and the second filter 111 are easily maintained or inspected.

Furthermore, in this forklift truck 3, the unit cooler 1 is formed in a rectangular shape having longitudinal sides extending in a front-rear direction, the unit cooler 1 is low in height, and the heat releasing port 13c is located at the front end of the headguard 3a, so that the warm air does not blow onto the driver M.

### Second Embodiment

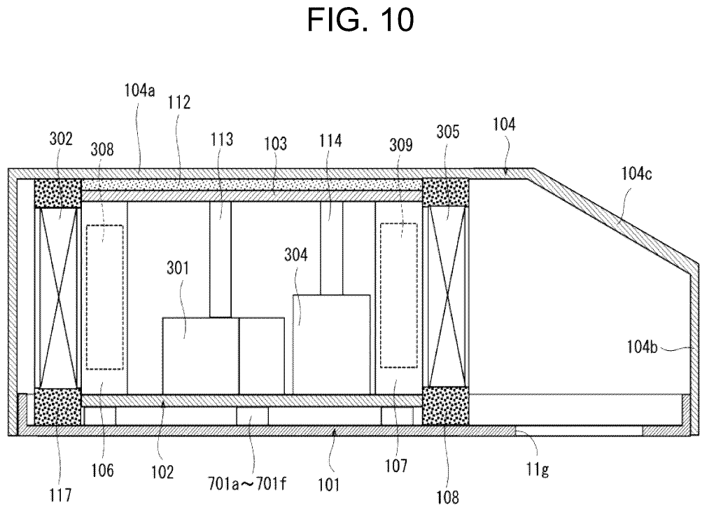

In the unit cooler 1 of the first embodiment, although both the condenser 302 and the evaporator 305 extend out of the base plate 102, the third case 108 as the collision cushioning member is provided only for the evaporator 305. On the other hand, in a unit cooler 1 of the second embodiment, as illustrated in FIG. 10, a fourth case 117 as the collision cushioning member is provided on the outer peripheral surface of the condenser 302 that includes the extending portion 302a. The fourth case 117 and the third case 108 are formed in plane symmetrically, and the fourth case 117 has the first layer 108a, the second layer 108b, the third layer 108c, and grooves 108e, 108f, similarly to the third case 108. The other components are the same as those in the first embodiment.

In this unit cooler 1, the third case 108 and the fourth case 117 may cushion an impact of a collision of the condenser 302 and the evaporator 305 with the under cover 101 or the top cover 104. In addition, the first layer 108a of the fourth case 117 may prevent a high temperature of the condenser 302 from negatively affecting the cold air.

In this unit cooler 1, the fourth case 117 may prevent combustion of the condenser 302. The condenser 302 is hardly deformed by the vibrations from the outside due to the fourth case 117, which contributes to superior durability. The other effects are the same as those in the first embodiment.

Although the present invention has been described above based on the first and the second embodiments, the present invention is not limited to the above-described first and the second embodiments and may be modified as appropriate within a gist of the present invention.

For example, the unit cooler of the present invention may be used in an electric forklift truck of a counter type, a picking type, a 3-way type, or a refrigerator-freezer type, and may be widely used in industrial vehicles such as various engine forklift trucks, transportation equipment, or towing trucks.

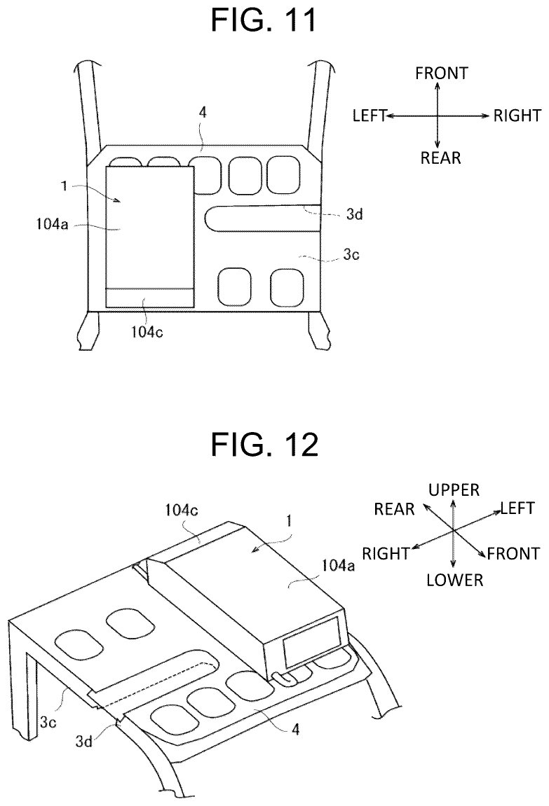

For example, in the counter type electric forklift truck, as illustrated in FIG. 11 and FIG. 12, a cutout 3d for hanging the battery may be formed in the headguard 3c. In order to prevent the unit cooler 1 from overlapping with the cutout 3d, the condenser 302 and the evaporator 305, which are relatively large components in the refrigeration cycle, are positioned at both ends of the unit cooler 1 with their long sides aligned with the short sides of the unit cooler 1, and the other components forming the refrigeration cycle, such as the electric compressor 301, the expansion valve 303, or the accumulator 304 are accommodated between the condenser 302 and the evaporator 305. Thus, these components forming the refrigeration cycle are unitized. In this case, since the unit cooler 1 of the first and the second embodiments are formed in the rectangular shape having the longitudinal sides extending in the front-rear direction, the unit cooler 1 may be mounted on the left side of the cutout 3d, that is, the unit cooler 1 may be mounted so as to avoid the cutout 3d. Even when a cover 4 made of transparent resin is disposed on the headguard 3c, the unit cooler 1 is miniaturized so as not to cover the whole cover 4, so that the unit cooler 1 does not interfere with the diagonal upper field of vision of the driver M.

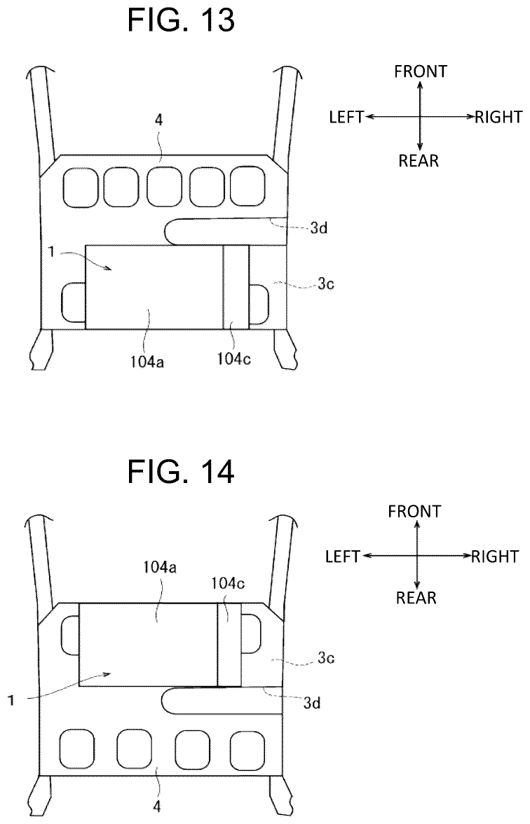

In addition, the mounted state of this unit cooler 1 is not limited to one in which the unit cooler 1 is mounted on the headguard 3c so as to extend in a front-rear direction of the headguard 3c. For example, as illustrated in FIG. 13, this unit cooler 1 may be mounted behind the cutout 3d so as to extend in a left-right direction of the headguard 3c. Alternately, as illustrated in FIG. 14, this unit cooler 1 may be mounted in front of the cutout 3d so as to extend in the left-right direction of the headguard 3c. In these cases, it is determined as desired whether the heat releasing port 13c and the inclined plate 104c are located on the left side or the right side of the headguard 3c.

The anti-vibration member of the unit cooler in the present invention is not limited to the fastening members 701a to 701f described above. The anti-vibration member of the unit cooler in the present invention may be the first member or the second member having the external screw portion or having the internal screw portion.

### INDUSTRIAL APPLICABILITY

The present invention is applicable to a unit cooler mountable on industrial vehicles or the like as an option.

### REFERENCE SIGNS LIST

100 housing
101 under cover
102 base plate
103 upper plate
104 top cover
106 first case
107 second case
108 third case (collision cushioning member)
108a first layer
108b second layer
108c third layer
108e, 108f groove
108g, 109h cutout
117 fourth case (collision cushioning member)
300 air conditioner
301 electric compressor
302 condenser
303 expansion valve (decompression device)
305 evaporator
308 first fan
309 second fan
701a to 701f fastening members

1. A unit cooler comprising:
a housing; and
an air conditioner that is accommodated in the housing and forms a refrigeration cycle, the air conditioner cooling air and supplying the air to an outside of the housing, wherein the housing has:
a base plate on which the air conditioner is mounted;
an under cover that is disposed under the base plate; and
a top cover that is fixed to the under cover and surrounds the air conditioner together with the under cover,
the air conditioner has an electric compressor, a condenser, a decompression device, an evaporator, a first fan adjacent to the condenser, and a second fan adjacent to the evaporator,
a fastening member that has a vibration isolating property is provided between the base plate and the under cover,
at least one of the condenser and the evaporator is disposed between the under cover and the top cover and has an extending portion that extends out of the base plate in a direction opposite from the fan adjacent to the at least one of the condenser and the evaporator, and
a collision cushioning member that cushions an impact of a collision between the at least one of the condenser and the evaporator and the under cover or the top cover is provided on the extending portion.

2. The unit cooler according to claim 1, wherein
the housing has an upper plate that is disposed between the top cover and the base plate,
the first fan is accommodated in a first case made of metal,
the second fan is accommodated in a second case made of metal, and
the first case and the second case are located between the base plate and the upper plate and fixed to the base plate and the upper plate.

3. The unit cooler according to claim 1, wherein
the condenser has the extending portion, and
the collision cushioning member includes at least a first layer of the first layer that has predetermined thermal insulation, a second layer that is located between the first layer and the condenser, and a third layer that is located between the first layer and the under cover and between the first layer and the top cover.

4. The unit cooler according to claim 1, wherein
the evaporator has the extending portion, and
the collision cushioning member includes at least a first layer of the first layer that has predetermined thermal insulation, a second layer that is located between the first layer and the evaporator, and a third layer that is located between the first layer and the under cover and between the first layer and the top cover.

5. The unit cooler according to claim 1, wherein
the collision cushioning member has heat resistance, flame retardancy, and a self-extinguishing property.

6. The unit cooler according to claim 1, wherein
the collision cushioning member has a groove that allows the collision cushioning member to be deformed.

7. The unit cooler according to claim 1, wherein
the collision cushioning member has a cutout into which the evaporator is fitted and guides condensation water generated in the air conditioner onto the under cover.
